(19) United States
(12) Patent Application Publication
(10) Pub. No.: US 2025/0011040 A1
(43) Pub. Date: Jan. 9, 2025

(54) FRUIT BASKET WITH INSERT FOR PROTECTION AGAINST INSECTS

(71) Applicant: Bamodi GmbH, Berlin (DE)

(72) Inventor: Samuel Bodner, Berlin (DE)

(21) Appl. No.: 18/756,054

(22) Filed: Jun. 27, 2024

(30) Foreign Application Priority Data
Jul. 5, 2023 (DE) 20 2023 103 746.1

(51) Int. Cl. B65D 25/02; B65D 21/02; B65D 51/24; B65D 85/34

(52) U.S. Cl. CPC B65D 25/02; B65D 21/0211; B65D 21/0217; B65D 51/242; B65D 85/34

(57) ABSTRACT

A fruit basket, including: an outer basket with a base part, a surrounding grid adjoining the base part, and an upper grid ring; an inner basket capable of being inserted into the outer basket from above without play and consisting of a tight-meshed grid mesh; and a lid capable of being placed in a formfitting manner on the inner basket.

### CROSS-REFERENCE TO RELATED APPLICATIONS

This application claims benefit of German Patent Application No. 20 2023 103 746.1, filed on 5 Jul. 2023, the contents of which are incorporated herein by reference in their entirety.

### BACKGROUND

### Field

The invention relates to a fruit basket.

### Related Art

Conventional fruit baskets have the disadvantage that insects or other small animals can gain access to the fruit contained therein. These can either attack the fruit or cling to it, so that when a piece of fruit is removed, an insect clinging to it is also removed. If care is not taken, this can lead to serious health problems and even death if a piece of fruit is consumed with a wasp or bee.

It is known to design fruit containers as bonnets that can be partially folded in. It is also known to form a fruit basket as a tight-meshed dome-shaped basket on which a dome-shaped lid made of the same material can be placed.

### SUMMARY

Based on the foregoing, the object of the invention is to provide a fruit basket which is characterized by rigidity.

In accordance with the invention, this object is achieved by a fruit basket comprising an outer basket with a base part, an adjoining circumferential grid and an upper grid ring, an inner basket which can be inserted into the outer basket from above without play and consists of a tight-meshed grid, as well as a lid that can be formfittingly applied onto the inner basket.

This allows the outer basket to provide the fruit basket with sufficient rigidity, while the insertable inner basket can be designed to be tight-meshed and soft—for example, in the manner of a fly screen. Alternatively, the inner basket can also be inherently stable, in particular, made of metal, especially aluminum.

The separation of the two baskets also ensures that the inner basket is easy to clean.

The outer basket and inner basket are preferably made of metal or plastic.

According to an advantageous further development of the invention, its lid is adapted to the contour of the base part, so that several fruit baskets can be stacked. There is therefore a formfitting connection in the horizontal direction, so that the base part of a stacked fruit basket can be placed on the lid of the underlying fruit basket without slipping, so that multiple fruit baskets can be stacked on top of each other. It is particularly preferable for the outer shape of the lid to be concave and for the base part to be matchingly convex.

According to an advantageous further development of the invention, the inner basket has a large number of openings, each with a cross-sectional area of less than 1 mm². As a result, virtually no insects can penetrate into the interior and at the same time, sufficient air exchange is made possible. It is particularly preferable that the inner basket consists of a foil with regularly arranged holes in the manner of a perforated plate.

According to an advantageous further development of the invention, the lid forms a closed surface, i.e., it has no openings. The lid can be made of a translucent material, or of metal or wood. This design prevents dust or other materials from penetrating into the interior and contaminating the fruit.

According to an advantageous further development of the invention, the lid consists entirely or partially of an inherently stable, tight-meshed grid. With this design, the fruit in the basket is visible and it is therefore easy to determine the amount of fruit still contained. The lid can preferably be made of metal, plastic, wood, or glass.

According to an advantageous further development of the invention, the lid consists wholly or partly of a rigid ring within which a tight-meshed grid is arranged. It is possible to connect the rigid ring to a rigid center by several radial connecting webs, so that a handle can be attached to the lid.

According to an advantageous further development of the invention, the lid has a seal on the outer circumference, to form a sealing connection to the inner basket. Such a seal should be as soft as possible in order to effectively prevent gaps between the basket and the lid through which insects could penetrate. The seal should ensure that insects and other small animals cannot pass through a gap between the lid and the inner basket.

According to a further advantageous development of the invention, a handle is arranged centrally on the lid to facilitate removal of the lid and removal of pieces of fruit.

According to an advantageous further development of the invention, the handle has a folded out and a folded in position, in which it rests flat on the lid. In the unfolded position, the handle preferably protrudes vertically from the lid in order to facilitate grasping. In the folded-in position, the handle can be arranged in a recess so that the handle does not protrude upwards beyond the outer side of the lid and thus the fruit basket can be stacked.

According to an advantageous further development of the invention, the fruit basket comprises a base tray, which can alternatively be inserted between the base plate and the inner basket or into the inner basket. The fruit is thus placed on this tray, which makes it easy to clean the fruit basket base. In normal use with an inner basket, the base tray is placed inside the inner basket. However, it is also possible to use the fruit tray without the inner basket, especially if it is only used for a short time, e.g., as part of a meal or catering service. In such a case, the base tray can be placed directly in the outer basket.

According to an advantageous further development of the invention, the grid edge of the outer basket consists of a number of evenly spaced vertical struts, the upper ends of which open into an annular outer basket edge. This makes it possible to achieve a visually appealing design with a high degree of rigidity.

According to an advantageous further development of this design, the inner basket has an outwardly protruding inner basket edge, which can form-fittingly rest on the outer basket edge of the outer basket and at the same time fix the inner basket in position. This makes it possible to achieve a sealed connection between the inner basket and the outer basket. By “sealing”, it is meant that insects and other small animals cannot pass through.

According to an advantageous further development of this design, the lid fits formfittingly on the inner basket edge, whereby a sealing connection between the components is achieved and insects or other small animals cannot enter the interior of the fruit basket.

According to an advantageous further development of the invention, the top of the lid is shaped like a concave tray so that objects can also be placed on the lid. In particular, it is possible to place some of the fruit on the lid for direct access and to keep other pieces of fruit inside the fruit basket.

Further advantages, features, and details can be found in the following description, in which at least one example embodiment is described in detail—with reference to the drawings, if necessary. Identical, similar, and/or functionally identical parts are provided with the same reference numerals.

### BRIEF DESCRIPTION OF THE DRAWINGS

In the drawings:

FIG. 1 shows an exploded view of the fruit basket according to the invention;

FIG. 2 shows a perspective view of the inner basket;

FIG. 3 shows a perspective view of an embodiment of the fruit basket;

FIG. 4 shows a perspective view of a possible use of the fruit basket in a stacking arrangement; and

FIG. 5 shows a perspective view of a possible use of the fruit basket in a further stacking arrangement.

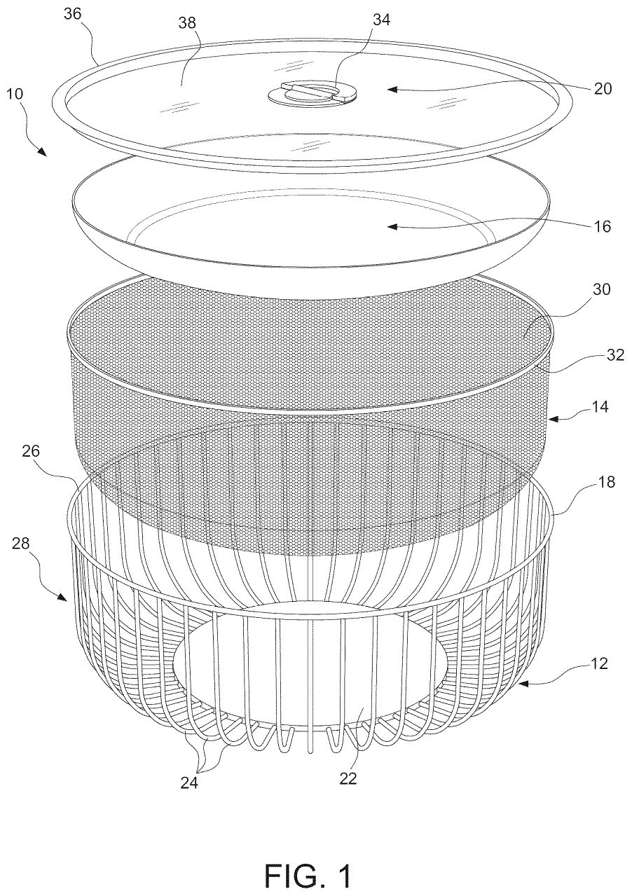

### DETAILED DESCRIPTION

The fruit basket 10 shown in the figures consists of an outer basket 12, an inner basket 14 which can be inserted into and removed from it—preferably without play—, a base tray 16 which can be inserted into the outer basket 12 or the inner basket 14, and a lid 20 which can be placed in a sealing manner on the outer basket edge 18 of the outer basket 12.

The outer basket 12 comprises a base part 22, to which a row of preferably arcuate grid bars 24 are connected, the upper ends of which terminate in a closed grid ring 26 and form a closed grid 28.

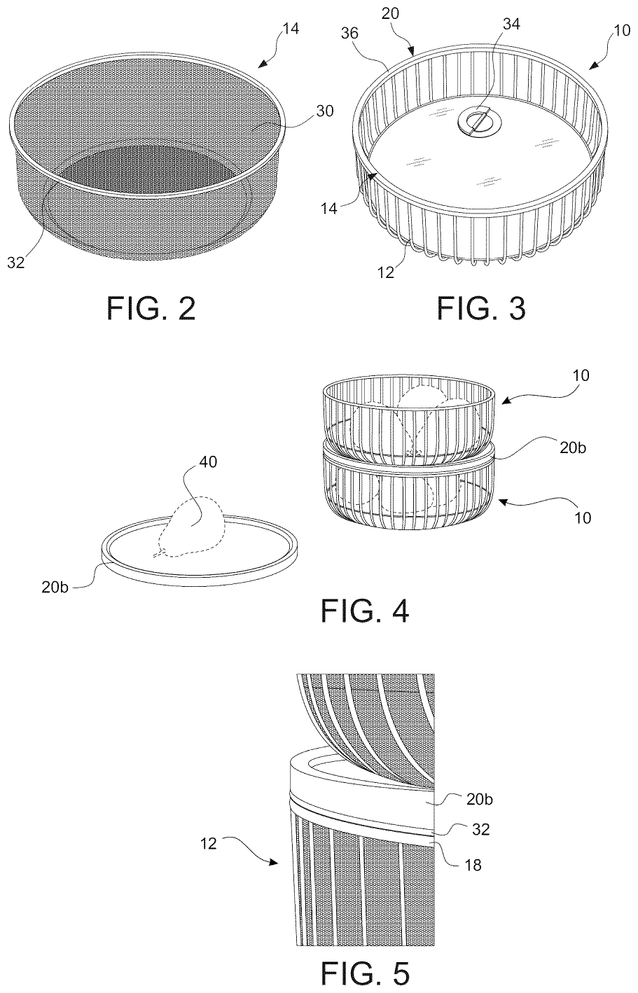

The inner basket 14 shown in FIG. 2, which can be inserted into the outer basket 12, preferably comprises a tight-meshed grid mesh 30 with a plurality of openings, each having a cross-sectional area of less than 1 mm². In particular, the grid mesh 30 can consist of a perforated plate. The inner basket 14 also preferably has a circumferential inner basket edge 32 at the upper edge, which is adapted to the shape of the outer basket edge 18, so that both lie sealingly on top of each other, so that insects cannot pass through between them, as shown in FIG. 5.

FIG. 3 shows a perspective view of an embodiment of the fruit basket 10, in which a transparent lid 20 with a handle 34 is attached. The handle 34 is shown in a folded position in which it barely protrudes beyond the lid 20. However, the handle 34 can be folded out and protrude vertically from the lid to facilitate gripping.

In the illustrated embodiment, the lid 20 has a rigid outer ring 36, wherein the surface 38 of the lid 20 can preferably consist of a soft or rigid tight-meshed grid. This can also be made of other materials such as wood or metal, glass, or plastic.

As shown in FIG. 4, the lid 20b can be rigid—in this case made of wood—and have a concave surface so that two fruit baskets 10 can be stacked on top of each other. Preferably, the concave surface shape of the lid 20b and the base of the outer basket 12 are preferably matched to one another in such a way that a formfitting connection is created, so that the upper fruit basket 10 cannot slip on the lid 20b of the lower fruit basket 10. FIG. 4 also shows the lid 20b of the upper fruit basket 10 separately from the latter with a piece of fruit 40 lying on it. This shows that the lid 20b can be used as an independent fruit tray. The underside of the lid 20b is adapted to the shape of the inner basket edge 32 in order to enable a sealing and formfitting connection in the horizontal direction.

Although the invention has been illustrated and explained in more detail by preferred example embodiments, the invention is not limited by the disclosed examples and other variations can be derived from them by the skilled person without departing from the scope of protection of the invention. It is therefore clear that a large number of possible variations exist. It is also clear that embodiments mentioned by way of example really only represent examples which are not to be understood in any way as limiting, for example, the scope of protection, the possible applications or the configuration of the invention. Rather, the preceding description and the description of the figures enable the person skilled in the art to implement the example embodiments in concrete terms, wherein the person skilled in the art, based on the knowledge of the invention can realize a variety of modifications, for example with regard to the function or arrangement of individual elements mentioned in an example embodiment, without leaving the scope of protection defined by the claims and their legal equivalents, such as by further explanations in the description of the invention.

### LIST OF REFERENCE NUMERALS

10 Fruit basket
12 Outer basket
14 Inner basket
16 Base tray
18 Outer basket edge
20 +b Lid
22 Bottom part
24 Grid bars
26 Grid ring
28 Grid
30 Grid mesh
32 Inner basket edge
34 Handle
36 Outer ring
38 Surface area of the lid
40 Piece of fruit

1. A fruit basket, comprising:
an outer basket with a base part, a surrounding grid adjoining the base part, and an upper grid ring;
an inner basket capable of being inserted into the outer basket from above without play and consisting of a tight-meshed grid mesh; and
a lid capable of being placed in a formfitting manner on the inner basket.

2. The fruit basket according to claim 1, wherein the lid is adapted to a contour of the base part, so that multiple fruit baskets are capable of being stacked.

3. The fruit basket according to claim 1, wherein the inner basket has a plurality of openings each with a cross-sectional area of less than 1 mm².

4. The fruit basket according to claim 1, wherein the lid forms a closed surface.

5. The fruit basket according to claim 1, wherein the lid wholly or partially comprises a tight-meshed grid mesh.

6. The fruit basket according to claim 1, wherein the lid consists wholly or partly of a rigid outer ring, within which a tight-meshed grid mesh is arranged.

7. The fruit basket according to claim 1, wherein the lid has a seal on an outer circumference in order to form a sealing connection to the inner basket or outer basket.

8. The fruit basket according to claim 1, wherein a handle is arranged centrally on the lid.

9. The fruit basket according to claim 8, wherein the handle has an unfolded position and a folded position, in which the handle rests flat on the lid.

10. The fruit basket according to claim 1, comprising a base tray capable of being alternatively inserted between the base plate and the inner basket or into the inner basket.

11. The fruit basket according to claim 1, wherein a grid edge of the outer basket consists of a number of evenly spaced vertical struts, upper ends of the struts open into an annular outer basket edge.

12. The fruit basket according to claim 11, wherein the inner basket has an outwardly projecting inner basket edge which rests formfittingly on the outer basket edge of the outer basket and fixes the inner basket.

13. The fruit basket according to claim 12, wherein the lid fits formfittingly on the inner basket edge.

14. The fruit basket according to claim 1, wherein an upper side of the lid is shaped like a concave tray.
